(19) United States
(12) Patent Application Publication
(10) Pub. No.: US 2024/0376003 A1
(43) Pub. Date: Nov. 14, 2024

(54) AGGREGATE, STRUCTURAL CONCRETE WITH AGGREGATE, AND METHODS OF FORMING SAME

(71) Applicant: Nano and Advanced Materials Institute Limited, Shatin (HK)

(72) Inventors: Shuai Zou, Shatin (HK); Chung Kong Chau, Shatin (HK); Sheng Yi Lin, Shatin (HK); Lai Ming Leung, Shatin (HK); Man Lung Sham, Shatin (HK)

(21) Appl. No.: 18/658,015

(22) Filed: May 8, 2024

Related U.S. Application Data
(60) Provisional application No. 63/501,426, filed on May 11, 2023.

(51) Int. Cl. C04B 18/02; C04B 18/10; C04B 18/14; C04B 28/02; C04B 111/00

(52) U.S. Cl. CPC C04B 18/021; C04B 18/101; C04B 18/141; C04B 18/146; C04B 28/02; C04B 2111/00017

(57) ABSTRACT

An aggregate (12, 16) is disclosed as including a core (12a) made at least partly of biochar (10, 14, 26, 28), and a shell (12b) encapsulating the core, the shell being made of ordinary portland cement (OPC) and ground granulated blast-furnace slag (GGBS). Structural concrete (30) including such an aggregate is also disclosed.

This application claims priority from U.S. Patent Application No. 63/501,426 filed on 11 May 2023, the content of which being incorporated herein by reference in its entirety as if fully set forth herein.

### FIELD OF THE INVENTION

This invention relates to an aggregate (in particular an aggregate with at least biochar), structural concrete with such aggregate, and methods of forming such aggregate and such structural concrete.

### BACKGROUND OF THE INVENTION

High carbon emissions and natural aggregate shortage are two issues facing the construction industry. On the one hand, the building and construction sector emits 39% of process-related global carbon dioxide (CO₂). On the other hand, uncontrolled mining of natural aggregate has caused profound impacts on the ecology and resulted in shortages of natural aggregates for the construction industry. Thus, developing carbon-reducing and natural aggregate substitution technologies are significant for achieving the ambitious carbon neutrality target and sustainable development of the construction industry.

Biochar is the lightweight black residue, made of carbon and ashes, remaining after the pyrolysis of biomass, and is a form of charcoal. Biochar is a stable solid that is rich in pyrogenic carbon and can endure in soil for thousands of years. Because of the carbon storage function of biochar, it is a carbon reduction solution applicable to construction materials. However, directly utilizing biochar as cement or aggregate substitutions would deteriorate the mechanical properties of concrete especially when the utilizing volume exceeds a certain threshold.

It is thus an objective of the present invention to provide an aggregate, structural concrete with such aggregate, and methods of forming such aggregate and such structural concrete in which the above shortcoming is mitigated, or at least to provide a useful alternative to the public.

### SUMMARY OF THE INVENTION

According to a first aspect of the present invention, there is provided an aggregate including a core made at least partly of biochar, and a shell encapsulating said core, wherein said shell is made at least partly of a cementitious material and/or an alkali-activated material.

According to a second aspect of the present invention, there is provided a structural concrete including at least a matrix material and an aggregate, said aggregate including a core made at least partly of biochar, and a shell encapsulating said core, wherein said shell is made at least partly of a cementitious material and/or an alkali-activated material.

According to a third aspect of the present invention, there is provided a method of forming an aggregate, including a step (a) of encapsulating a core made at least partly of biochar by a shell made at least partly of a cementitious material and/or an alkali-activated material.

According to a fourth aspect of the present invention, there is provided a method of forming a structural concrete, including mixing at least a matrix material with an aggregate, said aggregate including a core made at least partly of biochar, and a shell encapsulating said core, wherein said shell is made at least partly of a cementitious material and/or an alkali-activated material.

### BRIEF DESCRIPTION OF THE DRAWINGS

Embodiments of the present invention will now be described, by way of examples only, with reference to the accompanying drawings, in which:

FIG. 1a shows a number of loose biochar;

FIG. 1b shows a number of aggregate pellets formed of the loose biochar of FIG. 1a according to the present invention;

FIG. 2 shows a sectional view of an aggregate according to the present invention;

FIG. 3 shows schematically the calculation of carbon footprint of the aggregates of FIG. 1b;

FIG. 4a shows a number of densified biochar;

FIG. 4b shows a number of aggregate pellets formed of the densified biochar of FIG. 4a according to the present invention;

FIG. 5 is a schematic view showing densification of loose biochar into densified biochar;

FIG. 6 shows the particle size distribution of ordinary portland cement (OPC) and ground granulated blast-furnace slag (GGBS) which may be used in forming aggregates according to the present invention;

FIG. 7 shows the loose bulk density and apparent density (both in kg/m³) of aggregate according to the present invention against the curing time (in days);

FIG. 8 shows the crushing strength (in MPa) of aggregate according to the present invention against the curing time (in days);

FIG. 9 shows the water adsorption (in wt %) of aggregate according to the present invention against the curing time (in days);

FIG. 10 shows schematically the carbon footprint assessment for 1 ton of the aggregate according to the present invention; and

FIG. 11 shows a structural concrete according to the present invention.

### DESCRIPTION OF EMBODIMENTS OF THE INVENTION

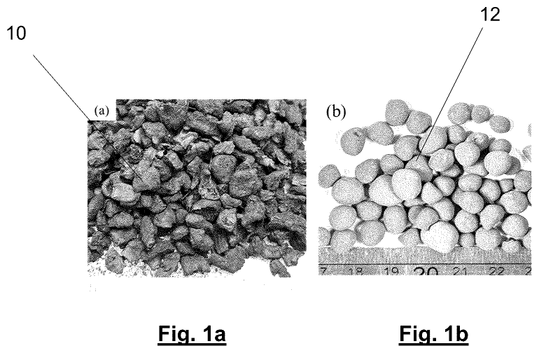

FIG. 1a shows a number of loose biochar 10, and FIG. 1b shows synthetic aggregate in the form of pellets 12 formed of the loose biochar 10 of FIG. 1a according to the present invention.

Table 1 below shows, as an example, the ingredients and their respective amount for forming the aggregate pellets 12 of FIG. 1b by the loose biochar 10 of FIG. 1a according to a first example of a method according to the present invention:

TABLE 1

Shell Materials

| OPC | GGBS | Loose | Water | Curing |
|---|---|---|---|---|
| (kg) | (kg) | Biochar (kg) | (kg) | Conditions |
| 150 | 600 | 94 | 157 | Sealing |

To form the aggregate pellets 12 according to an example of the present invention with the above amount of the ingredients, the loose biochar 10 and the cementitious shell materials (including ordinary portland cement (OPC) and ground granulated blast-furnace slag (GGBS)) were firstly pre-mixed in a pelletizer (such as of a diameter of 100 cm, a depth of 25 cm, and a tilting angle of) 45° under a uniform speed of rotation of 15 rpm for 2 minutes. An appropriate amount of water was sprayed onto the materials in the following 15 minutes during which the pelletizer continued to rotate. The pelletizer continued to rotate for three (3) more minutes after spraying of water for the further compaction of the freshly pelletized aggregate.

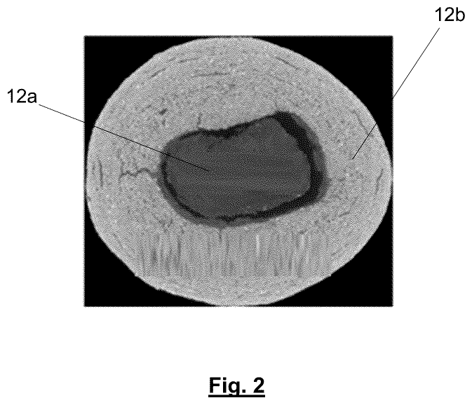

The freshly pelletized aggregate was cured at a sealing condition under room temperature and humidity. As shown in FIG. 2, the produced aggregate 12 based on the loose biochar 10 is in the form of a pellet of a core-shell structure, having a biochar core 12a encapsulated by a shell 12b formed of OPC and GGBS. It is envisaged that, in addition to biochar 10, the core 12a may also include solid wastes, such as fly ash, slag, recycled concrete fine, and recycled glass.

While the ratio between the weight of the respective material OPC, GGBS, loose biochar 10 and water in Table 1 is around 1:4:0.6:1, it is envisaged that the ratio between the weight of these materials may be 0.75-1.25:3-5:0.45-0.75:0.75-1.25.

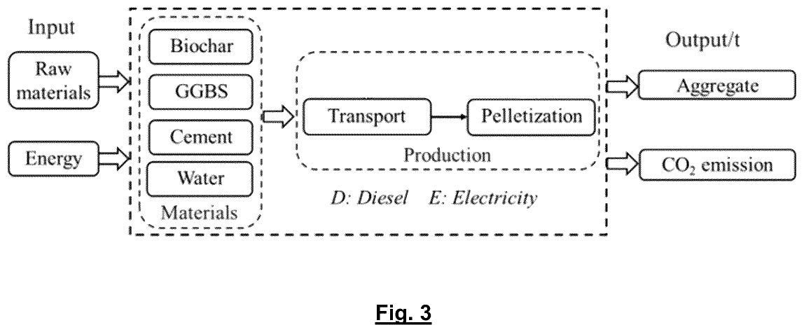

The carbon footprint of the aggregate 12 thus formed is calculated according to FIG. 3. The results show that the aggregate 12 based on the loose biochar 10 is of a loose bulk density of 789 kg/m³, a crushing strength of 6.84 MPa, and carbon emission as low as −69 kgCO₂ eq/t, in which “CO₂ eq” means “carbon dioxide equivalent”. As biochar 10 is a carbon-storage material, by encapsulating the biochar 10 (with or without solid wastes) by the shell 12b, the aggregate 12 is “carbon negative,” in the sense that the amount of carbon stored/encapsulated in the aggregate 12 is more than the amount of carbon produced in manufacturing the aggregate 12, including the carbon emission sourced materials (including OPC, GGBS, water), transport, and palletization process.

In addition, as the aggregate 12 has a rigid shell 12b, the aggregate 12 not only overcomes the drawbacks of biochar 10 due to its high porosity and water absorption, but also attains good strength.

While in the above example the cementitious shell materials include ordinary portland cement (OPC) and ground granulated blast-furnace slag (GGBS), other cementitious materials (such as waste glass powder, recycled powder, silica fume, and incinerator bottom ash (IBA)) may also be used.

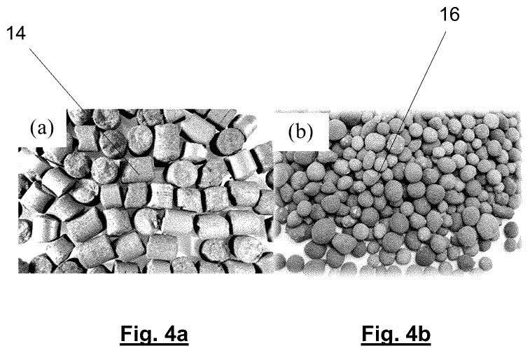

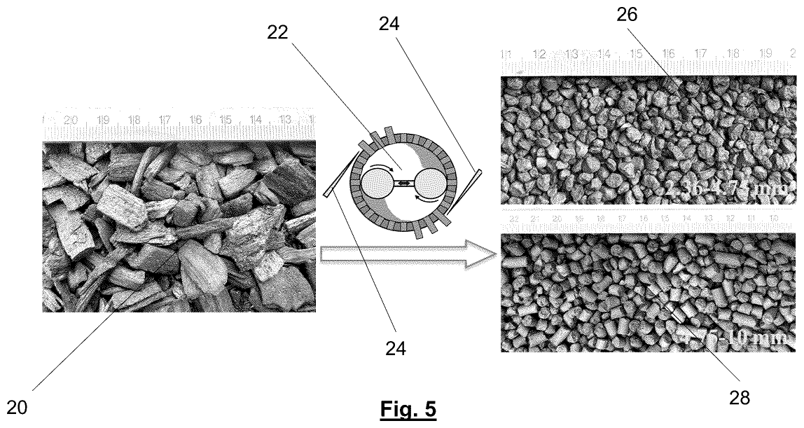

In a second example, synthetic aggregate 16 in the form of pellets (as shown in FIG. 4b) were formed with densified biochar 14 (as shown in FIG. 4a). FIG. 5 shows schematically the densification of loose waste wood biochar into densified/compacted biochar pellets, e.g., by compression. As shown in FIG. 5, a number of pieces of loose waste wood biochar 20 were fed into a compressor 22, and mixed with oil (such as engine oil) and sand. The ratio between the weight of loose biochar 20, oil and sand may be 7.5-12.5:0.75-1.25:0.75-1.25, such as 10:1:1.

Upon rotation of the compressor, the loose biochar 20 was mixed with oil and sand and compressed/compacted by the compressor 22, and was extruded through a number of outlets, to be cut into pellets of densified/compacted biochar 26, 28 by cutters 24. The outlets were of different sizes, so that densified biochar pellets 26, 28 of different sizes were formed. For example, the densified biochar pellets 26 are of a size between 2.36 mm and 4.75 mm, whereas the densified biochar pellets 28 are of a size between 4.75 mm and 10 mm. It should be noted that the manner and way of compressing/compacting the loose biochar 20 into densified/compacted biochar 26, 28 is not limited to that discussed above.

The respective loose bulk density and apparent density of the loose biochar 20, the densified/compacted biochar pellets 26 of a size between 2.36 mm and 4.75 mm, and the densified/compacted biochar pellets 28 of a size between 4.75 mm and 10 mm are as shown in Table 2.

TABLE 2

| | Loose | Compacted Biochar | Compacted Biochar |
|---|---|---|---|
| | Biochar | (2.36 mm-4.75 mm) | (4.75 mm-10 mm) |
| Loose Bulk Density | 188.8 | 403.7 | 407.3 |
| (kg/m³) | | | |
| Apparent Density | 483.5 | 1338.3 | 1269.9 |
| (kg/m³) | | | |

“Loose Bulk Density” of the biochar is calculated by dividing the total weight of the biochar by the total volume of the biochar (including the space between and within the biochar particulates), and “Apparent Density” of the biochar is calculated by dividing the total weight of the biochar by the total volume of the biochar (including the space within, but excluding the space between, the biochar particulates).

Table 3 below shows the ingredients and their respective amount for forming the aggregate pellets 16 of FIG. 4b by the densified biochar 14 of FIG. 4a by cold-bonding, according to a second example of a method according to the present invention:

TABLE 3

Shell Materials

| OPC | GGBS | Densified | Water | Curing |
|---|---|---|---|---|
| (kg) | (kg) | Biochar (kg) | (kg) | Conditions |
| 138 | 552 | 165 | 145 | Sealing |

The raw core materials (i.e., densified biochar pellets 14, 26, 28) and cementitious shell materials (OPC and GGBS) were firstly pre-mixed in a pelletizer (diameter: 100 cm, depth: 25 cm, and tilting angle: 45°) under a uniform rotation speed of 15 rpm for 2 minutes. An appropriate amount of water was sprayed on the materials during continuous rotation of the pelletizer for another 15 minutes. The pelletizer rotated for another 3 minutes after spraying of water for the further compaction of the freshly pelletized aggregate. The freshly pelletized aggregate was cured at a sealing condition under room temperature and humidity. The aggregate 16 in the form of pellets based on the densified biochar 14, 26, 28 is shown in FIG. 4b. Such aggregate pellets 16 are of a core-shell structure, each including a core of densified biochar (with or without solid wastes) encapsulated by a shell formed of OPC and GGBS.

For OPC and GGBS forming the shell, their respective size is from 1 μm-100 μm, and their respective composition may be as shown in Table 4.

TABLE 4

| Material | SiO₂ | Al₂O₃ | CaO | MgO | SO₃ | Fe₂O₃ | K₂O | TiO₂ | LOI |
|---|---|---|---|---|---|---|---|---|---|
| OPC | 18.7 | 4.4 | 68.1 | — | 5.24 | 2.7 | 0.56 | 0.32 | 0.98 |
| GGBS | 30.5 | 13.4 | 42.3 | 8.36 | 3.09 | 0.26 | 0.44 | 1.33 | 1.32 |

In Table 4, “LOI” stands for “loss on ignition”.

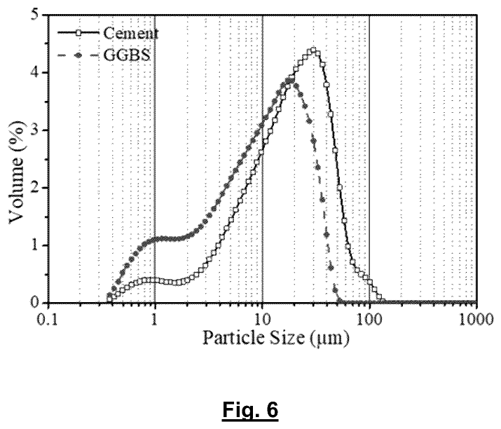

FIG. 6 shows the particle size distribution of the OPC (cement) and GGBS used for forming the shell of the aggregate 16 according to the above method. In addition, the apparent density of OPC is 3,100 kg/m³, that of GGBS is 2,800 kg/m³, and that of the compacted biochar is 1,338 kg/m³.

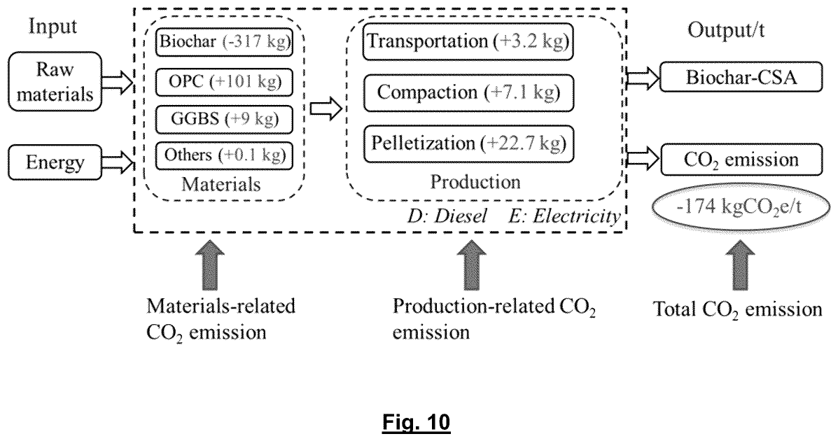

The carbon footprint of such aggregate pellets 16 was calculated according to FIG. 10. The results are that, after curing for 28 days, the aggregate 16 based on densified biochar 14, 26, 28 attained a loose bulk density of 878 kg/m³, a crushing strength of 7.6 MPa, and a carbon emission as low as −174 kgCO₂ eq/t. Again, such aggregate pellets 16 are carbon negative, as the amount of carbon stored/encapsulated in the aggregate 16 is more than the amount of carbon produced in manufacturing the aggregate 16, including the carbon produced in manufacturing the other materials (including OPC, GGBS, water), transport, and palletization process.

While the ratio between the weight of the respective material OPC, GGBS, densified biochar, and water in Table 3 is around 10:40:12:1.05, it is envisaged that the ratio between the weight of these materials may be 7.5-12.5:36-44:9-15:0.79-1.31.

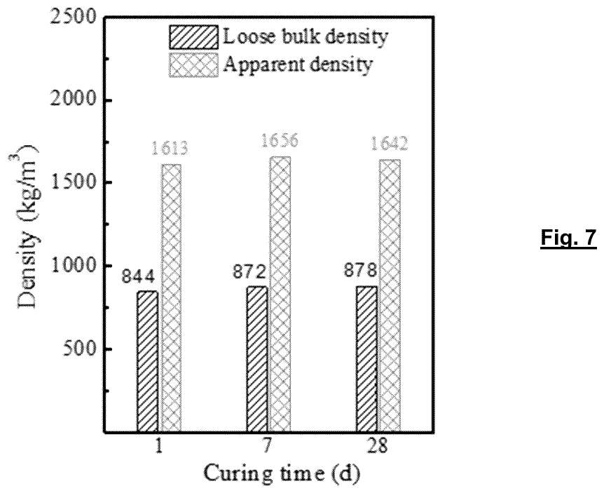

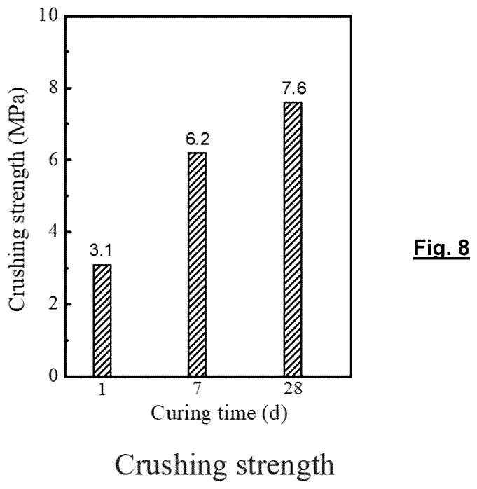

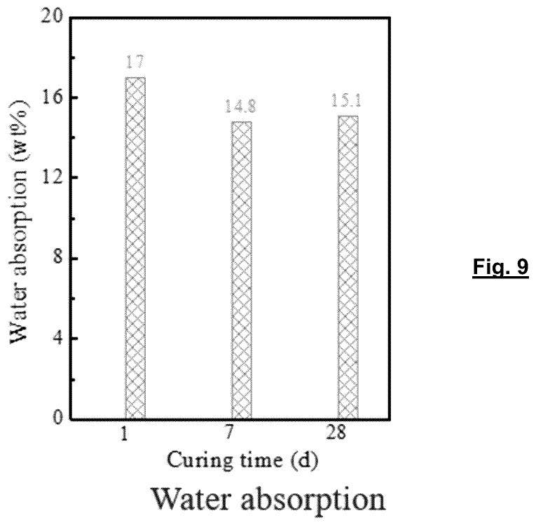

FIG. 7 shows the loose bulk density and apparent density (both in kg/m³) of aggregate pellets according to the present invention against the curing time (in days), FIG. 8 shows the crushing strength (in MPa) of aggregate pellets according to the present invention against the curing time (in days), and FIG. 9 shows the water adsorption (in wt %) of aggregates according to the present invention against the curing time (in days).

In a further example, aggregate based on densified biochar with enhanced strength is formed of the ingredients shown in Table 5.

TABLE 5

| Shell Materials | | | | | |
|---|---|---|---|---|---|
| OPC | GGBS | Silica | Densified | Water | Curing |
| (kg) | (kg) | Fume (kg) | Biochar (kg) | (kg) | Conditions |
| 138 | 486 | 66 | 165 | 145 | Sealing/ |
| | | | | | Carbonation |

The cementitious shell materials (including OPC, GGBS and silica fume) were designed by modified Andreasen-Andersen model to achieve closet packing. The raw core materials (including densified biochar) and shell materials were firstly pre-mixed in a pelletizer (such as of a diameter of 100 cm, a depth of 25 cm, and a tilting angle of) 45° under a uniform speed of rotation of 15 rpm for 2 minutes. An appropriate amount of water was sprayed on the materials in the following 15 minutes during which the pelletizer continuously rotated. The pelletizer rotated for another 3 minutes after spraying of water to further compact the freshly pelletized fresh aggregate.

After that, nano materials such as nano silica was sprayed onto the shell of the aggregate to form a reactive surface to enhance and facilitate bonding of the aggregate with concrete matrix material when the aggregate is utilized for concrete production.

The freshly pelletized aggregate was cured at a sealing condition under room temperature and humidity and carbon dioxide environment such as a pressure of 1 Pa and a carbon dioxide concentration of 100%. Carbon curing can further improve the aggregate strength and reduce carbon emission. The results show that the aggregate based on densified biochar with packing design and sealing curing for 28 days with another 6 hours of carbon curing attained a crushing strength of 8.138 MPa, showing a strength enhancement.

Table 6 below shows the ingredients for producing structural concrete by using the carbon negative aggregate based on densified biochar as shown in FIG. 4 (b), with a size up to 10 mm.

TABLE 6

| | | | Carbon | | |
|---|---|---|---|---|---|
| Cement | GGBS | Silica | Negative | Water | Admixtures |
| (kg) | (kg) | Fume | Aggregate (kg) | (kg) | (kg) |
| 200 | 340 | 60 | 1036 | 180 | 10 |

The admixtures in Table 6 are additives to the structural concrete, such as superplasticizer (water reducer), fiber, hydroxypropyl methylcellulose (HPMC), and so on.

While the ratio of the weight of the carbon negative aggregate according to the present invention, cement, GGBS, silica fume, carbon negative aggregate, water and admixtures in Table 6 is 20:34:6:104:18:1, it is envisaged that the ratio may be in the range of 15-25:26-43:4.5-7.5:78-130:13.5-22.5:0.75-1.25.

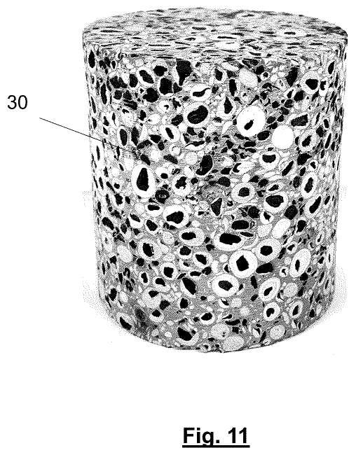

The cementitious materials (including cement, GGBS and silica fume) and natural aggregate were designed by modified Andreasen-Andersen model to achieve closet packing. These materials were mixed with water to form a matrix material, and the aggregate according to the present invention was added to and mixed with the matrix material to form structural concrete 30, in particular the cylindrical cored concrete sample with a diameter of 80 mm as shown in FIG. 11.

The results show that the structural concrete 30 attained a 28d compressive strength higher than 40 MPa, a density less than 1900 kg/m³, and carbon emission of −7.86 kgCO₂ eq/m³, which means that the structural concrete 30 is also carbon negative. It should be noted that the carbon negative structural concrete 30 may be designed and formed to be of different densities and compressive strengths according to specific needs.

While in the above example the cementitious materials include OPC, GGBS and silica fume, other cementitious materials (such as waste glass powder, recycled powder, and incinerator bottom ash (IBA)) may also be used.

While in the above examples the shell is made at least of a cementitious material, it is envisaged that, instead of or in conjunction with a cementitious material, the shell may also be made of an alkali-activated material. The alkali-activated materials could be one or more of the precursors (such as GGBS, fly ash, silica fume, waste glass powder and so on) alkali-activated by alkaline materials (such as water glass, sodium hydroxide, and so on).

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. An aggregate including:
a core made at least partly of biochar, and
a shell encapsulating said core,
wherein said shell is made at least partly of a cementitious material and/or an alkali-activated material.

2. The aggregate of claim 1, wherein said cementitious material is at least one of cement, ground granulated blast-furnace slag (GGBS), waste glass powder, recycled powder, silica fume, and incinerator bottom ash (IBA).

3. The aggregate of claim 1, wherein said core is of a loose biochar with a loose bulk density from 100 kg/m³ to 300 kg/m³, or of a densified biochar with a loose bulk density higher than 300 kg/m³.

4. The aggregate of claim 1, wherein said shell further includes at least a nano material.

5. The aggregate of claim 4, wherein said nano material is silica fume or nano silica.

6. The aggregate of claim 1, wherein said aggregate is carbon negative.

7. The aggregate of claim 1, wherein said aggregate is in pellet form.

8. A structural concrete including at least the aggregate according to claim 1 and at least a matrix material.

9. The structural concrete of claim 8, wherein said matrix material is cementitious.

10. The structural concrete of claim 8, wherein said matrix material includes at least one of cement, GGBS, and silica fume.

11. The structural concrete of claim 8, wherein said structural concrete is carbon negative.

12. The structural concrete of claim 8, wherein said structural concrete is of a 28d compressive strength of at least 30 MPa.

13. A method of forming an aggregate, including a step (a) of encapsulating a core made at least partly of biochar by a shell made at least partly of a cementitious material, an alkali-activated material, or both a cementitious material and an alkali-activated material.

14. The method of claim 13, wherein said shell is made at least partly of cement and ground granulated blast-furnace slag (GGBS).

15. The method of claim 13, further including, before said step (a), a step (b) of compacting said biochar to increase its density.

16. The method of claim 13, further including a step (c) of applying at least a nano material on said shell.

17. The method of claim 16, wherein said nano material is silica fume or nano silica.

18. The method of claim 13, wherein said aggregate is formed by cold-bonding.

19. A method of forming a structural concrete, including mixing at least the aggregate of claim 1 with at least a matrix material.

20. The method of claim 19, wherein said matrix material is cementitious.

21. The method of claim 19, wherein said matrix material includes at least one of cement, GGBS, silica fume, waste glass powder, recycled powder, and incinerator bottom ash (IBA).
